(19) United States
(12) Patent Application Publication
(10) Pub. No.: US 2007/0150502 A1
(43) Pub. Date: Jun. 28, 2007

(54) Methods, systems and computer program products for calendar based delivery of downloadable content

(76) Inventors: L. Scott Bloebaum, Cary, NC (US); Ivan Nelson Wakefield, Cary, NC (US); Gregory A. Dunko, Cary, NC (US)

Correspondence Address: MYERS BIGEL SIBLEY & SAJOVEC, P.A., P.O. BOX 37428, RALEIGH, NC, 27627, US

(21) Appl. No.: 11/315,915

(22) Filed: Dec. 22, 2005

(51) Int. Cl. G06F 7/00

(52) U.S. Cl. 707/102

(57) ABSTRACT

Methods of accessing downloadable content using a calendar application on a device include identifying an event in the calendar application of the device that includes downloadable content identification data. Access information for the downloadable content is provided to a content access application of the device based on the identified event and the downloadable content identification data. The downloadable content is accessed based on the provided access information using the content access application. The downloadable content may be, for example, a podcast. Related computer program produces, systems and mobile terminals are also provided.

### BACKGROUND OF THE INVENTION

The present invention relates to communications devices and more particularly, to communications devices including broadcast media tuning features and methods and computer program products for operating the same.

Smart devices such as personal computers and the like are now generally provided with communications capabilities. For example, such devices are typically provided with wired or wireless access to the Internet to allow for downloading and viewing of content from Internet Service Providers (ISPs), electronic mail (email) communications and the like. In addition, such devices are often also configured for presenting other forms of media such as music or video.

Mobile devices, such as mobile terminals, are increasingly being provided with capabilities that were previously found only in personal computers and the like. Mobile terminals are, typically, primarily purchased by a user to obtain access to wireless phone services through a cellular network telecommunications provider. However, as the processing capabilities, memory and the like included in such mobile terminals increases, an additional level of user functionality is being packaged in such mobile terminals to leverage the benefit to a user of an electronic device that is typically kept with the user at most times. For example, many mobile terminals are currently provided with a camera, allowing pictures to be taken by a user and transmitted from the mobile terminal to others. Many mobile terminals also include messaging capability, such as electronic mail (e-mail), short message service (SMS) and multimedia message service (MMS) capabilities. The mobile terminal may be configured for Internet communications using, for example, the Wireless Application Protocol (WAP). Browser applications or the like may then provide access to a variety of downloadable content, such as podcasts, which may be downloaded to the mobile terminal and presented to a user.

Another area where additional user functionality is increasingly being provided on mobile terminals that was previously provided on personal computers is in the area of personal assistant type application, such as a calendar application. Accordingly, mobile terminals often allow a user to set up events that may trigger alarms or the like to notify the user of impending events and provide information about the event, such as topic, attendees and the like.

### SUMMARY OF THE INVENTION

In some embodiments of the present invention, computer implemented methods of accessing downloadable content using a calendar application on a device include identifying an event in the calendar application of the device that includes downloadable content identification data. Access information for the downloadable content is provided to a content access application of the device based on the identified event and the downloadable content identification data. The downloadable content is accessed based on the provided access information using the content access application. The downloadable content may be, for example, a podcast.

In other embodiments, the downloadable content is a podcast and the content access application includes an RSS reader. Accessing the downloadable content may include receiving the downloadable content at the device. The downloadable content identification data may include a designation of desired content associated with the event and accessing the downloadable content may include determining availability of the downloadable content based on the designation of desired content associated with the event. The downloadable content may be a plurality of podcasts of a type and the designation of desired content may include a designation of the type. Determining the availability of the downloadable content may include determining the availability of new content for the plurality of podcasts and accessing the downloadable content may further include downloading ones of the plurality of podcasts having new content to the device.

In further embodiments, the event has an associated start trigger and accessing the downloadable content includes determining availability of new content for the downloadable content responsive to the start trigger and notifying a user of the device of the availability of new content for the downloadable content responsive to the start trigger. A selection of the downloadable content is received from the user responsive to notifying the user and the downloadable content is downloaded responsive to the received selection. The start trigger may include a start time and detection of a device time corresponding to the start time may trigger associated activities. When the downloadable content is a plurality of podcasts, a selection of at least one of the plurality of podcasts having new content may be received as the selection from the user.

In yet other embodiments, the event has an associated start time and accessing the downloadable content includes determining availability of new content for the downloadable content at a selected time prior to the start time and receiving the downloadable content at the device prior to the start time when it is determined that new content is available for the downloadable content. The method may further include identifying the selected time prior to the start time based on a second event in the calendar application. Identifying the selected time may include detecting a time in the calendar without any scheduled event and selecting the time without any scheduled event as the selected time prior to the start time.

In further embodiments, identifying an event includes detecting a time in the calendar without any scheduled event and identifying the time without any scheduled event as the event and associating the downloadable content identification data with the event. Where the downloadable content is a plurality of podcasts, associating the downloadable content identification with the event may be preceded by obtaining the plurality of podcasts, associating ones of the plurality of podcasts having a same type and generating the downloadable content identification to identify the associated ones of the plurality of podcasts. Associating ones of the plurality of podcasts may include generating a plurality of sets of podcasts, each having an associated different type and identifying an event may include identifying a plurality of events each of which is associated with one of the sets of podcasts.

In yet other embodiments, the downloadable content includes a plurality of podcasts having a same associated type and identifying an event includes identifying an event having the same associated type as the event in the calendar application and generating the downloadable content identification to identify the plurality of podcasts having the same type. Accessing the downloadable content may include notifying a user of the device of availability of the downloadable content at a time associated with the event and receiving a designation of desired delivery of the downloadable content from the user responsive to notifying the user.

In further embodiments, accessing the downloadable content includes retrieving stored configuration information associated with a user of the device and determining a designation of desired delivery of the downloadable content from the retrieved configuration information. The downloadable content may have an associated type and the configuration information may include a plurality of designations of desired delivery, ones of which are associated with corresponding types of downloadable content. Retrieving configuration information may include determining the associated type of the downloadable content and retrieving one of the plurality of designations of desired delivery associated with the determined associated type.

In other embodiments, providing the access information includes providing the access information from the calendar application to the content access application using a designated application programming interface (API) of the content access application. The event may have a start time and an associated base time zone and the device may be in a different time zone and identifying the event may include determining if the event is a fixed time zone or a local time zone event type. Accessing the downloadable content may include presenting the downloadable content to a user of the device at the start time based on the different time zone when the event is a local time zone event type.

In yet further embodiments, mobile terminals include a portable housing and an output device in the housing. A wireless communication network interface circuit in the housing is configured to request and receive downloadable content. A controller in the housing is configured to execute a calendar application configured to identify events associated with the downloadable content, the events including downloadable content identification data, and to generate access information for the downloadable content associated with events based on the associated events and the downloadable content identification data. The controller is further configured to execute a content access application module configured to receive the access information from the calendar application and to access the downloadable content based on the access information for the downloadable content and the events associated with the downloadable content and to present the downloadable content on the output device. The downloadable content may be podcasts and the content access application module may be a browser and/or a media player in some embodiments.

In other embodiments, computer implemented methods of presenting of downloadable content using a calendar application on a device include downloading the downloadable content to the device using a content access application of the device. Notification of availability of the downloaded downloadable content is provided from the content access application to the calendar application. Responsive to the notification, an event is generated in the calendar application including an identification of the downloaded downloadable content to initiate presenting of the downloaded downloadable content responsive to a start trigger associated with the event. The start trigger may be a start time of the event. Providing the notification may include providing the notification from the content access application to the calendar application using a designated application programming interface (API) of the calendar application.

In further embodiments, computer implemented methods of calendar based presentation of downloadable content on a mobile terminal include identifying an event having a start time and an associated base time zone and that includes an identification of the downloadable content. It is determined if the event is a fixed time zone or a local time zone event type. A time at a the mobile terminal is determined based on a local time zone at a current location of the mobile terminal, the local time zone being different from the base time zone. The downloadable content is presented to a user of the mobile terminal at the start time based on the local time zone when the event is a local time zone event type and at the start time based on the base time zone when the event is a fixed time zone event type.

While described above primarily with reference to apparatus and method aspects, it will be understood that the present invention also includes computer program products for a mobile terminal and communication devices.

### BRIEF DESCRIPTION OF THE DRAWINGS

FIG. 1 is a schematic block diagram of a mobile terminal according to some embodiments of the present invention and an exemplary base station transceiver.

FIGS. 2 to 6 are flowcharts illustrating methods of accessing downloadable content according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “mobile terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances, which include a radio frequency receiver. As used herein, “mobile terminals” may be portable, transportable, installed in a vehicle (aeronautical, maritime, or land-based), or situated and/or configured to operate locally and/or in a distributed fashion at any other location(s) on earth and/or in space. As used herein, a “mobile device” includes mobile terminals as well as mobile devices that do not support wireless communications.

Downloading of media content for recreational and/or educational purposes is becoming increasingly popular as the range of content available for downloading and the availability of devices for accessing and presenting the content to users increases. In particular, one form of such downloadable content, podcasts, is becoming more popular and the number of podcasts available is ballooning. In some embodiments of the present invention, to better control access to desirable podcasts and the timeliness of delivery, podcasts may be linked to predefined events, alarms, or time such as may be entered in the calendar program of a mobile terminal. Such events, alarms, or time may trigger the download and notification or initiation of playing of such a podcast.

In some embodiments, when the user's device downloads the content, such as a podcast, it can send a message to the calendar or alarm application in the device to schedule an event at a future time. At this future time, the device may send the user a notification with, for example, a list of content available for consumption. Furthermore, the downloaded content could be linked to an existing calendar event. For instance, if the user has put in a recurring commute event in the calendar, the downloaded content could be linked (e.g. by building a list) to that event. In other embodiments, the application could create different calendar events based on type of content downloaded (e.g. sports news in the morning, NPR stories at evening commute, etc.).

Further, content assessment/download/use may be linked to “local” time in some embodiments. Mobile terminals may have the ability to “know” local time (independent of time zone). One mechanism for doing so with a mobile terminal is via use of the feature Network Information and Time Zone (NITZ). Other methods may also be known. With this knowledge, a device may “modify” the normal day activities to the local time. For example, a user (when in his home location) may prefer to download the very latest news/sports podcasts just prior to his morning jog (e.g., 6:30 am EST). The user may go on a business trip to a different time zone. He may still desire to maintain his routine, so the user may prefer that the latest podcasts are downloaded to his device during his morning jog in the new time zone. Through use of NITZ, the mobile terminal could determine local time and apply this to the user's routine, even for the new time zone.

In some embodiments, a user programs events in his calendar application. At some later time, the event time arrives and some podcatching/podscasting action (e.g., determining new content is available, downloading the content etc.) is taken. During or at a time otherwise associated with the event, the end user consumes the podcast content and/or consumes the content at some later time. Thus, in such embodiments, events are initially programmed into the device calendar application. These events may be entered manually by the user (select time, event description, preferences, etc.), may be entered via device synchronization with a personal computer (PC) or remote synchronization service, received via a pushed event from some other source (friend/acquaintance, web service, etc.) and/or the like.

In some embodiments, the user selects preferences when programming the event. These preferences may, for example, include types of podcast information to download for this specific event, trigger time for download (e.g., at event start, 10 minutes prior to event, etc.), event trigger alert and so on. If selection is to begin downloading at the start of event, there may be a user interface (UI) presentation to the user to allow selection of which currently available sources of information the user wishes to download. In this instance, the operations may include, at the start trigger for the calendar event, having the content access application (e.g., podcatching software such as a podcast enabled browser) determine which sources have available new content. The user may then be presented with this list of available updates and select which ones are desired. The podcatching software may then pull (download) those selected updates.

In other embodiments, the podcatching trigger (when to get updates) may be associated with a periodic trigger (every half hour starting two hours before a scheduled event), may be associated with a calendar event (as described above) and/or may be associated with “openings” in the calendar. That is, there may be “linkage” between the podcatching software and the calendar such that “future” open calendar times are identified, content is collected and the podcatching software then creates a calendar event in the open time and associates the collected content with that created calendar event. This may be triggered by the end time of a previously scheduled event and the lack of start of a succeeding event (as a way of identifying an opening in a device user calendar).

In further embodiments, the podcatching content type may be used for linking with a scheduled event type. For example, for an event, such as a scheduled ballgame, it may be preferable to download content related to sports. Thus, event types may be created that are associated with podcatching content types. In addition, the collection of content over time may be linked with a future event. For example, content may be collected on a daily basis for consumption once a month.

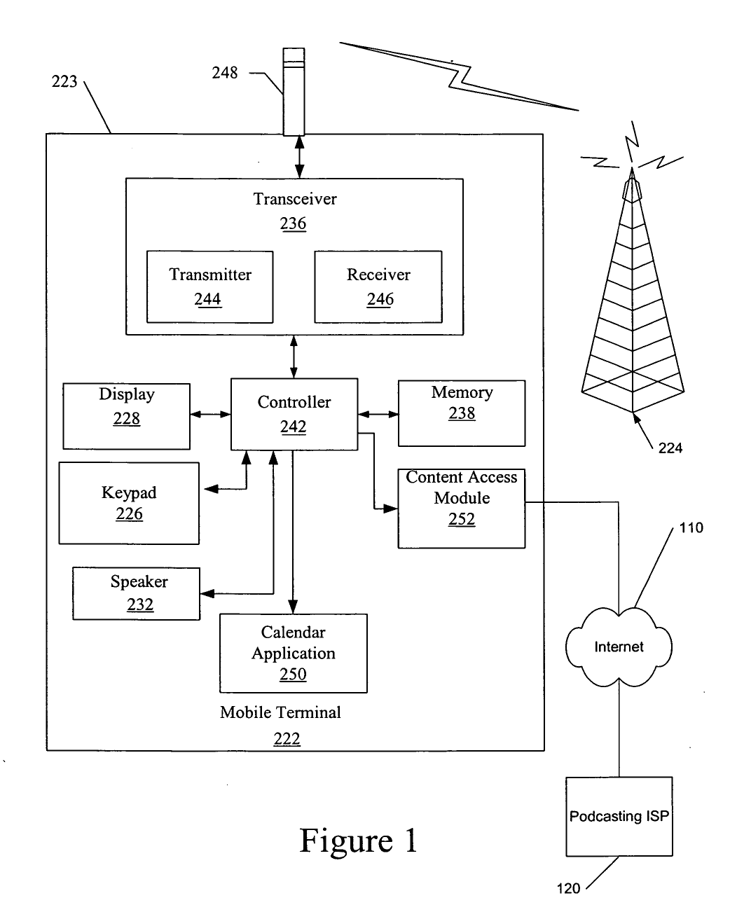

Embodiments of the present invention will now be described below with respect to FIGS. 1 through 6. Referring first to FIG. 1, a system for accessing downloadable content using a calendar application on a device is illustrated. More particularly, FIG. 1 is a schematic block diagram illustrating a mobile terminal 222 including downloadable content access and calendar capabilities in accordance with some embodiments of the present invention. FIG. 1 illustrates the mobile terminal 222 and a base station transceiver 224 of a wireless communications network. As shown in the embodiments of FIG. 1, the mobile terminal 222 is also communicatively coupled to the Internet 110. The mobile terminal 222 may request and receive downloadable content over the Internet 110 from sources, such as the podcasting Internet service provider (ISP) 120 schematically illustrated in FIG. 1.

The illustrated mobile terminal 222 includes a portable housing 223 and may include a keypad (or other man-machine interface) 226, a display 228, a speaker 232, a transceiver 236, a memory 238, a microphone, a calendar application module 250 and a content access module 252, any of which may communicate with a controller (processor) 242. The controller 242 can be any commercially available or custom microprocessor. All or a portion of the calendar application (module) 250 and/or the content access application (module) 252 may be implemented as software executing on the controller 242.

The transceiver 236 provides a wireless communication network interface circuit that typically includes a transmitter circuit 244 and a receiver circuit 246, which respectively transmit outgoing radio frequency signals to the base station transceiver 224 and receive incoming radio frequency signals, such as voice call and data signals, from the base station transceiver 224 via an antenna 248. The antenna 248 may be an embedded antenna, a retractable antenna or any antenna known to those having skill in the art. The radio frequency signals transmitted between the mobile terminal 222 and the base station transceiver 224 may include both traffic and control signals (e.g., paging signals/messages for incoming calls), which are used to establish and maintain a voice call communication with another party or to transmit and/or receive data, such as e-mail, SMS and/or MMS messages, with a remote device. More particularly, the data transmission/reception through the base station transceiver 224 may provide the connection between the content access module 252 and the Internet 110, which is schematically illustrated as a separate, direct link in FIG. 1. Similarly, a local area network (LAN) link may provide the connection between the content access module 252 and the Internet 110 in some embodiments. As such, the controller 242 may support various functions of the mobile terminal 222, including functions related to voice communications and data communications, such as a Wireless Application Protocol (WAP) link configured to request and receive downloadable content at the mobile terminal 222 using the base station transceiver 224 according to some embodiments of the present invention.

In some embodiments of the present invention, the base station transceiver 224 is a radio transceiver(s) that defines a cell in a cellular network and communicates with the mobile terminal 222 and other mobile terminals in the cell using a radio-link protocol. Although only a single base station transceiver 224 is shown, it will be understood that many base station transceivers may be connected through, for example, a mobile switching center and other devices, to define a wireless communications network. However, it will be understood that a communication device other than a mobile terminal coupled through a cellular network may be configured to operate in accordance with some embodiments of the present invention and the present invention is not limited to the particular configuration illustrated for explanatory purposes in FIG. 1.

As shown in the embodiments of FIG. 1, the calendar application 250, as executed by the controller 242, may be configured to identify events associated with downloadable content. The events may include downloadable content identification data, for example, an identification of a podcast available from the podcasting ISP 120. The calendar application 250 may further be configured to generate access information for the downloadable content associated with the event based on the associated event and the downloadable content identification data.

The content access module 252, as executed by the controller 242, may be configured to receive the access information from the calendar application 250 and to access the downloadable content based on the access information for the downloadable content and particulars of the event associated with the downloadable content. The content access module 252 may further be configured to present the downloadable content on an output device of the mobile terminal 222, such as the display 228 and/or the speaker 232. For example, the content access module 252 may be a browser application configured to identify new content for a podcast provided by the podcasting ISP 120 and obtain and present the new content. Furthermore, while shown as a single module in FIG. 1, the content access module 252 may be a plurality of modules, such as a plurality of browsers, different ones of which are configured to access and present different types of downloadable content. Similarly, separate application modules may be provided for presentation, downloading and/or identification of new content availability in some embodiments.

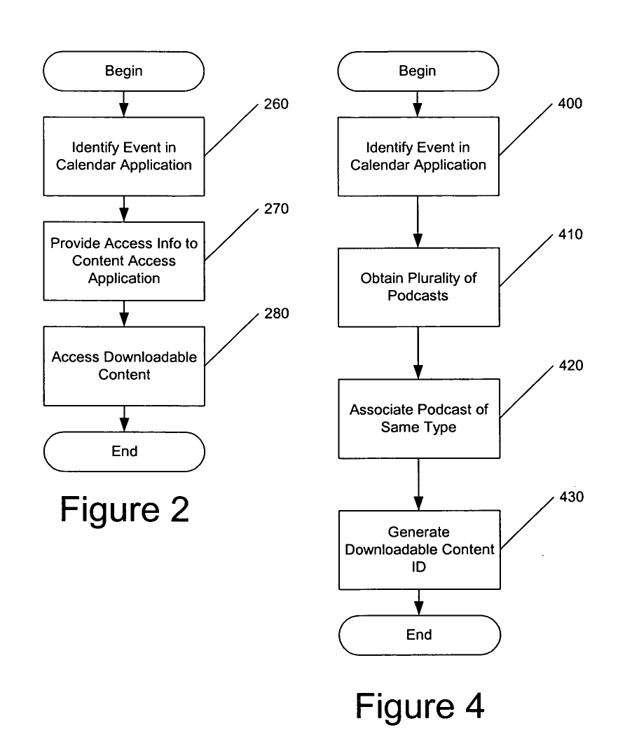

Some embodiments of methods for accessing downloadable content identified in or associated with a calendar event will now be described with reference to the flowchart illustrations of FIGS. 2-6. Referring first to the embodiments illustrated in FIG. 2, operations begin with identifying an event in the calendar application of the device, the event including downloadable content identification data (block 260). Access information for the downloadable content is provided to a content access application of the device based on the identified event in the downloadable content identification data (block 270). For example, the access information may be provided from the calendar application to the content access application using a designated application programming interface (API) of the content access application. The downloadable content is accessed based on the provided access information using the content access application (block 280). For example, the downloadable content may be a podcast and the content access application may be an RSS reader or an RSS reader-enabled browser or the like.

Operations at block 280 may include determining the availability of new content for one or more designated sources of downloadable content, downloading such new downloadable content and/or presenting the content to a user of the device in various embodiments of the present invention as will be further described herein. Furthermore, as will be explained in greater detail herein, the calendaring information may provide scheduling and/or start triggers for determining availability of new content, downloading content and/or presentation of such content, each of which may be separately and independently scheduled so long as the content is available at the time of presentation. Thus, an event in a calendar application of the device may include a designation of desired content associated with that event as downloadable content identification data and corresponding address information for the desired content may be provided as access information to the content access application to facilitate access to the desired content in connection with the scheduled event.

It will be understood that characteristics of the event other than the downloadable content identification data may affect accessing and presentation of the downloadable content, including the timing thereof and the role of the user in making subsequent designations of delivery and the like in various embodiments of the present invention. As such, accessing of the downloadable content more generally may be based upon provided access information based on both the downloadable content identification data and/or other aspects and characteristics of the identified event.

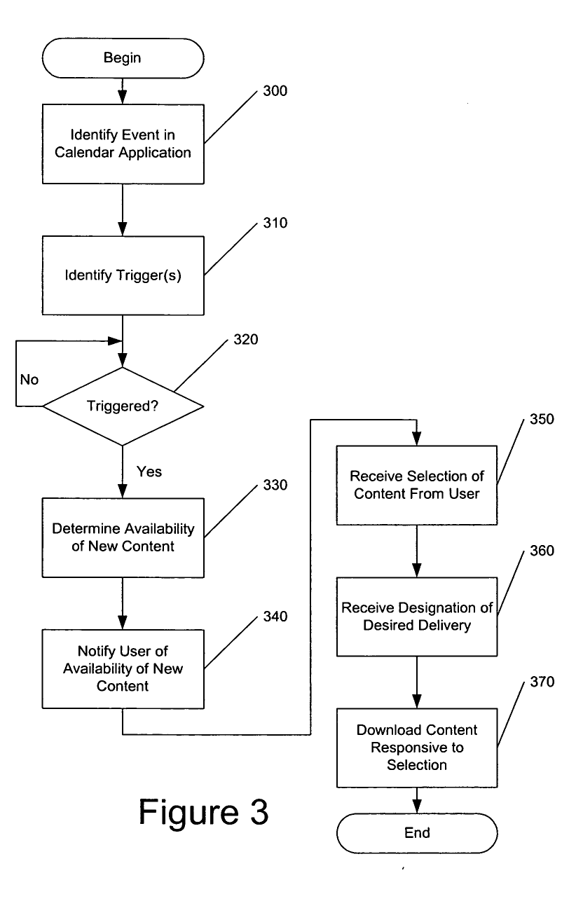

Further embodiments of computer implemented methods of accessing of downloadable content according to the present invention will now be described with reference to the flowchart illustration of FIG. 3. As shown in FIG. 3, operations begin by identifying an event in a calendar application of a device (block 300). One or more start triggers associated with the event are identified (block 310). For example, the event may have a start time and the start trigger may be the start time of the event or may be the start time of the event for presentation of downloadable content with an earlier specified time as a separate trigger for downloading of the content for later presentation to a user at the start time of the event. For the embodiments illustrated in FIG. 3, a common trigger is used for both determining availability of new content and obtaining and/or presenting that content.

As shown in the embodiments of FIG. 3, upon detecting the start trigger (block 320), the availability of new content for the identified downloadable content is determined (block 330). For example, where the downloadable content is a plurality of podcasts designated as of interest for the event, the availability of new content for each of the identified plurality of podcasts may be determined at block 330. It will be understood, however, that determining of availability of new content may not be linked to the triggering event and may, instead, occur at different intervals, which intervals may be triggered based on a start time or the like associated with the event in some embodiments of the present invention.

A user of the device is notified of the availability of new content for the downloadable content (block 340). For example, where the downloadable content includes a plurality of desired podcasts, a list of available podcasts having new content may be presented on a display of the device. A selection of one or more of the items of downloadable content is received from the user responsive to the notification (block 350). For example, a user may select displayed content items from a displayed list using a cursor, a touch screen display and/or the like.

As illustrated for the embodiments of FIG. 3, a designation of desired delivery for the requested downloadable content may also be received from a user responsive to the notification (block 360). The designated downloadable content is downloaded responsive to the received selection(s) from the user (block 370). In some embodiments, the downloadable content is downloaded and received at the device prior to a start time associated with the event when it is determined that new content is available for the designated downloadable content. Such downloading and reception of the downloadable content at the device and/or the determination of availability of new content may occur in some embodiments of the present invention without prompting the user for or receiving from a user a selection of downloadable content or a designation of desired delivery of such content and default conditions or the like may be used to automatically carry out such operations on the device without the requirement for further user intervention.

In some embodiments of the present invention, determination of the availability of new content may occur at a selected time prior to the start time of an event, where the selected time prior to the start time for determining the availability of and/or downloading new content may in turn be based on a second event in the calendar application. For example, the selected earlier time may be identified by detecting a time in the calendar without any scheduled event and selecting that time without any scheduled event as a selected time prior to the start time for determining availability of and/or downloading new content associated with the first event in the calendar.

In some embodiments of the present invention, operations for identifying an event in the calendar application at block 300 may themselves include detecting a time in the calendar without any scheduled event and identifying that time without any scheduled event as the event and associating the downloadable content identification data for a determined group of downloadable content with a newly scheduled event. Thus, for example, a device may be programmed with user preferences configuration information and proactively identify and gather a suitable grouping of new content, such as podcasts, that may be of interest to the user based on the configuration information, and schedule an organized presentation of such related information to a user at a time when the user does not have other scheduled activities. The configuration information in some embodiments may be obtained from a remote device, such as a configuration information server, accessible to the device.

In some embodiments of the present invention, rather than receiving a designation of desired delivery from a user at block 360, stored configuration information associated with the user of the device is received and the designation of desired delivery of the downloadable content is determined from the retrieved configuration information. In addition, the downloadable content may have an associated type and the configuration information may include a plurality of designations of desired delivery, ones of which are associated with corresponding types of downloadable content. The retrieved stored configuration information may then be reviewed to determine an appropriate designation of desired delivery for a particular downloadable content type.

Methods of accessing of downloadable content using a calendar application on a device according to further embodiments of the present invention will now be described with reference to the flowchart illustration of FIG. 4. As shown in FIG. 4, operations begin by identifying an event in the calendar application (block 400). For example, as described above, an event may be identified by proactively generating the event at an open time so as to provide a presentation of downloadable content to a user at a free time in the user's calendar based, for example, on known preferences information for the user. Operations at block 400 may instead include identifying an event in the user's calendar having an associated type that matches an associated type of one or more podcasts having a same associated type. For example, a plurality of podcasts identified by previously input configuration information for a user may be determined to have new content available. These podcasts may be type grouped, such as news podcasts, sports podcasts, and the like. The types used for categorizing the podcasts may correspond to event types in the calendar, such as attending a sporting competition or the like. Thus, identifying an event in a calendar application at block 400 may include searching in the calendar for an event having a type corresponding to a type of downloadable content for which new content is available for presentation to a user.

A plurality of identified podcasts associated with the identified event are obtained (block 410). Ones of the plurality of podcasts having a same type are associated (block 420). Downloadable content identification data is generated to identify the associated ones of the plurality of podcasts (block 430). More particularly, in some embodiments, a plurality of sets of podcasts may be generated, each having an associated different type and different ones of the sets may be associated with different events. Accordingly, operations as described for FIG. 4 may be used to generate an event and/or to convert an event already in the user's calendar to an event associated with downloadable content and having downloadable content identification data, which event may then be utilized as described previously with reference to FIGS. 2 and 3.

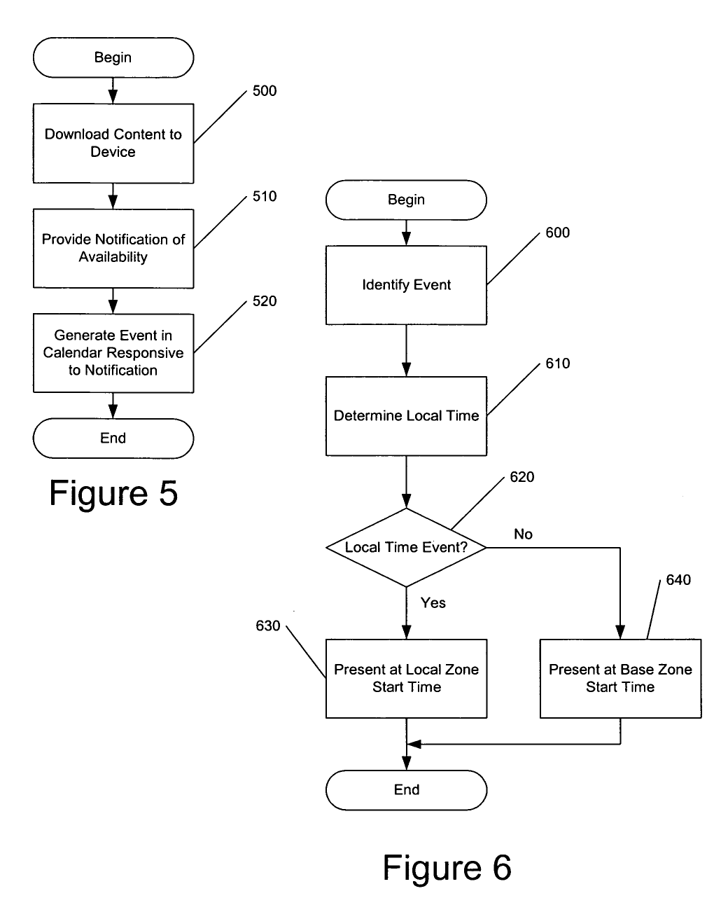

Methods for presenting of downloadable content using a calendar application on a device according to some embodiments of the present invention will now be described with reference to the flowchart illustration of FIG. 5. As shown in the embodiments of FIG. 5, operations begin by downloading the downloadable content to the device using a content access application of the device (block 500). Notification of availability of the downloadable content is provided from the content access application to the calendar application (block 510). An event is generated in the calendar application responsive to the notification (block 520). The generated event includes an identification of the downloaded content to initiate presenting of the downloaded content responsive to a start trigger associated with the generated event.

The start trigger may be, for example, a start time of the generated event, and the notification may be provided from the content access application to the calendar application using a designated application programming interface (API) of the calendar application. Accordingly, for the embodiments of FIG. 5, automatic interaction is provided between the content access application and the calendar application of the device by the content access application detecting the availability of new content and triggering generation of event by the calendar application to support presentation of the new content to the user.

Methods of calendar based presentation of downloadable content on a mobile terminal according to some embodiments of the present invention will now be described with reference to the flowchart illustration of FIG. 6. As shown for the embodiments of FIG. 6, operations begin by identifying an event having a start time in an associated base time zone (block 600). The identified event includes an identification of the downloadable content. A local time at the mobile terminal is determined based on a local time zone at a current location of the mobile terminal, where the local time zone is different from the base time zone associated with the identified event (block 610).

If it is determined that the identified event is a local time zone event type (block 620), the downloadable content is presented to a user of the mobile terminal at a start time based on the local time zone (block 630). If it is determined that the identified event is a fixed time zone event type (block 620), the downloadable content is presented to a user of the mobile terminal at a start time based on the base time zone (block 640). As such, for the embodiments illustrated in FIG. 6, the type designation of the identified event may be used to determine whether the downloadable content is presented based on local time or the time in the base time zone. For example, the downloadable content associated with the event may be associated with a meeting that will occur in the base time zone in which the user of the mobile terminal is to participate from the user's own local time zone. Accordingly, such events may be designated as fixed time zone event types so that the downloadable content is presented to the user in the local time zone and other meeting participants in the base time zone concurrently. Other more personal events, such as presentation of news podcasts during morning exercise for a user, may be designated as local time zone event types so that they may consistently be presented at the same time of day wherever a user travels.

As will be appreciated by one of skill in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer (i.e., controller of the user's mobile terminal), partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Furthermore, the present invention was described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 1-6 illustrate the architecture, functionality, and operations of some embodiments of methods, systems, and computer program products for accessing downloadable content using a calendar application. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A computer implemented method of accessing downloadable content using a calendar application on a device, comprising:
identifying an event in the calendar application of the device that includes downloadable content identification data;
providing access information for the downloadable content to a content access application of the device based on the identified event and the downloadable content identification data; and
accessing the downloadable content based on the provided access information using the content access application.

2. The method of claim 1, wherein the downloadable content comprises a podcast and wherein the content access application includes an RSS reader.

3. The method of claim 1, wherein accessing the downloadable content comprises receiving the downloadable content at the device.

4. The method of claim 1, wherein the downloadable content identification data comprises a designation of desired content associated with the event and wherein accessing the downloadable content comprises determining availability of the downloadable content based on the designation of desired content associated with the event.

5. The method of claim 4, wherein the downloadable content comprises a plurality of podcasts of a type and wherein the designation of desired content comprises a designation of the type and wherein determining the availability of the downloadable content comprises determining the availability of new content for the plurality of podcasts and wherein accessing the downloadable content further comprises downloading ones of the plurality of podcasts having new content to the device.

6. The method of claim 1, wherein the event has an associated start trigger and wherein accessing the downloadable content comprises:
determining availability of new content for the downloadable content responsive to the start trigger;
notifying a user of the device of the availability of new content for the downloadable content responsive to the start trigger;
receiving a selection of the downloadable content from the user responsive to notifying the user; and
downloading the downloadable content responsive to the received selection.

7. The method of claim 6, wherein the start trigger includes a start time.

8. The method of claim 6, wherein the downloadable content comprises a plurality of podcasts and wherein determining the availability of the downloadable content comprises determining the availability of new content for the plurality of podcasts and wherein receiving a selection comprises receiving a selection of at least one of the plurality of podcasts having new content.

9. The method of claim 1, wherein the event has an associated start time and wherein accessing the downloadable content comprises:
determining availability of new content for the downloadable content at a selected time prior to the start time; and
receiving the downloadable content at the device prior to the start time when it is determined that new content is available for the downloadable content.

10. The method of claim 9, wherein the method further comprises identifying the selected time prior to the start time based on a second event in the calendar application.

11. The method of claim 10, wherein identifying the selected time includes detecting a time in the calendar without any scheduled event and selecting the time without any scheduled event as the selected time prior to the start time.

12. The method of claim 1, wherein identifying an event comprises detecting a time in the calendar without any scheduled event and identifying the time without any scheduled event as the event and associating the downloadable content identification data with the event.

13. The method of claim 12, wherein the downloadable content comprises a plurality of podcasts and wherein associating the downloadable content identification with the event is preceded by:
obtaining the plurality of podcasts;
associating ones of the plurality of podcasts having a same type; and
generating the downloadable content identification to identify the associated ones of the plurality of podcasts.

14. The method of claim 13, wherein associating ones of the plurality of podcasts includes generating a plurality of sets of podcasts, each having an associated different type and wherein identifying an event comprises identifying a plurality of events each of which is associated with one of the sets of podcasts.

15. The method of claim 1, wherein the downloadable content comprises a plurality of podcasts having a same associated type and wherein identifying an event comprises:
identifying an event having the same associated type as the event in the calendar application; and
generating the downloadable content identification to identify the plurality of podcasts having the same type.

16. The method of claim 1, wherein accessing the downloadable content comprises:
notifying a user of the device of availability of the downloadable content at a time associated with the event; and
receiving a designation of desired delivery of the downloadable content from the user responsive to notifying the user.

17. The method of claim 1, wherein accessing the downloadable content comprises:
retrieving stored configuration information associated with a user of the device; and
determining a designation of desired delivery of the downloadable content from the retrieved configuration information.

18. The method of claim 17, wherein the downloadable content has an associated type and wherein the configuration information includes a plurality of designations of desired delivery, ones of which are associated with corresponding types of downloadable content and wherein retrieving configuration information includes determining the associated type of the downloadable content and retrieving one of the plurality of designations of desired delivery associated with the determined associated type.

19. The method of claim 1, wherein providing the access information comprises providing the access information from the calendar application to the content access application using a designated application programming interface (API) of the content access application.

20. The method of claim 1, wherein the event has a start time and an associated base time zone and wherein the device is in a different time zone and wherein identifying the event includes determining if the event is a fixed time zone or a local time zone event type and wherein accessing the downloadable content comprises presenting the downloadable content to a user of the device at the start time based on the different time zone when the event is a local time zone event type.

21. A computer program product for accessing downloadable content using a calendar application on a device, the computer program product comprising computer program code embodied in a computer readable medium, the computer program code comprising program code configured to carry out the method of claim 1.

22. A communication device configured to carry out the method of claim 1.

23. A mobile terminal configured to carry out the method of claim 1.

24. A mobile terminal, comprising:
a portable housing;
an output device in the housing;
a wireless communication network interface circuit in the housing configured to request and receive downloadable content; and
a controller in the housing configured to execute:
a calendar application configured to identify events associated with the downloadable content, the events including downloadable content identification data and to generate access information for the downloadable content associated with events based on the associated events and the downloadable content identification data; and
a content access application module configured to receive the access information from the calendar application and to access the downloadable content based on the access information for the downloadable content and the events associated with the downloadable content and to present the downloadable content on the output device.

25. The mobile terminal of claim 24, wherein the downloadable content comprises podcasts and wherein the content access application module comprises a browser.

26. A computer implemented method of presenting of downloadable content using a calendar application on a device, comprising:
downloading the downloadable content to the device using a content access application of the device;
providing notification of availability of the downloaded downloadable content from the content access application to the calendar application; and
generating, responsive to the notification, an event in the calendar application including an identification of the downloaded downloadable content to initiate presenting of the downloaded downloadable content responsive to a start trigger associated with the event.

27. The method of claim 26, wherein the start trigger comprises a start time of the event.

28. The method of claim 26, wherein providing the notification comprises providing the notification from the content access application to the calendar application using a designated application programming interface (API) of the calendar application.

29. A computer program product for presenting of downloadable content using a calendar application on a device, the computer program product comprising computer program code embodied in a computer readable medium, the computer program code comprising program code configured to carry out the method of claim 26.

30. A communication device configured to carry out the method of claim 26.

31. A mobile terminal configured to carry out the method of claim 26.

32. A computer implemented method of calendar based presentation of downloadable content on a mobile terminal, comprising:
identifying an event having a start time and an associated base time zone and that includes an identification of the downloadable content;
determining if the event is a fixed time zone or a local time zone event type;
determining a time at a the mobile terminal based on a local time zone at a current location of the mobile terminal, the local time zone being different from the base time zone; and
presenting the downloadable content to a user of the mobile terminal at the start time based on the local time zone when the event is a local time zone event type and at the start time based on the base time zone when the event is a fixed time zone event type.

33. A computer program product of calendar based presentation of downloadable content on a mobile terminal, the computer program product comprising computer program code embodied in a computer readable medium, the computer program code comprising program code configured to carry out the method of claim 32.

34. A mobile terminal configured to carry out the method of claim 32.
